(19) United States
(12) Patent Application Publication
(10) Pub. No.: US 2025/0287886 A1
(43) Pub. Date: Sep. 18, 2025

(54) AXIAL BLOWER VACUUM

(71) Applicant: Techtronic Cordless GP, Anderson, SC (US)

(72) Inventors: Lance A. Eckard, Anderson, SC (US); Ronald J. Hoffman, Anderson, SC (US); Josh Vanasse, Anderson, SC (US); Zhizhen He, Anderson, SC (US); Charles Kowalczyk, Anderson, SC (US); John Chastain, Taylors, SC (US); Zheng Jun Wang, Dongguan City (CN); Jin Cheng Li, Dongguan City (CN); Dong Wei Li, Dongguan City (CN)

(21) Appl. No.: 18/859,677

(22) PCT Filed: May 12, 2022
(86) PCT No.: PCT/CN2022/092464

§ 371 Date: Oct. 24, 2024

(51) Int. Cl. A01G 20/47; F04D 19/00; F04D 19/02; F04D 25/08; F04D 29/52

(52) U.S. Cl. CPC A01G 20/47; F04D 19/002; F04D 19/024; F04D 25/08; F04D 29/522

(57) ABSTRACT

An axial blower vacuum is provided. An airflow generation device includes a housing extending between a front end and a rear end, and a passageway that extends between a first opening and a second opening. The first opening is adjacent to the rear end of the housing. The device has a fan assembly positioned at least partly within the housing and including a first fan, a second fan, and a motor configured to drive rotation of the first fan and the second fan. The device includes a blower attachment and a vacuum attachment configured to interchangeably couple to the housing and/or the fan assembly at the rear end of the housing. The fan assembly is rotatable such that, in a first configuration, the first fan is disposed adjacent to the first opening, and in a second configuration, the second fan is disposed adjacent to the first opening.

### FIELD

The present disclosure relates generally to an outdoor tool, such as a blower, a vacuum and/or a mulcher and, more particularly, to an axial blower/vacuum.

### BACKGROUND

Outdoor tools such as blowers are commonly used to concentrate debris, e.g., leaves, using a blowing function. Traditional blowers have only with a blowing function and, as a result, a user needs to rely on another tool to collect the concentrated leaves. As a result, blower/vacuum outdoor power tools have been developed which can be used for both concentration of and collection of debris. However, existing blower/vacuum tools also have some disadvantages. For example, because blower/vacuums combine the two different, e.g., opposite, functions of blowing and suction, components needed to implement both blowing and suction functions into a single tool can be cumbersome. Moreover, users desire a blower/vacuum tool that is easy to facilitate mode switching between blowing and suction.

Accordingly, improved blower/vacuum tools are desired in the art. In particular, a blower/vacuum which provides easy and safe would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, an airflow generation device is provided. The airflow generation device includes a housing extending between a front end and a rear end. The airflow generation device includes a passageway that extends between a first opening and a second opening, and the first opening is adjacent to the rear end of the housing. The airflow generation device includes a fan assembly positioned at least partly within the housing. The fan assembly includes a first fan, a second fan, and a motor configured to drive rotation of the first fan and the second fan. The airflow generation device includes a blower attachment and a vacuum attachment configured to interchangeably couple to the housing and/or the fan assembly at the rear end of the housing. The fan assembly is rotatable such that, in a first configuration, the first fan is disposed adjacent to the first opening, and in a second configuration, the second fan is disposed adjacent to the first opening.

In accordance with another embodiment, an airflow generation device is provided. The airflow generation device includes a housing extending between a front end and a rear end. The airflow generation device includes a passageway that extends between a first opening and a second opening, and the first opening is adjacent to the rear end of the housing. The airflow generation device includes a fan assembly positioned at least partly within the housing. The fan assembly includes a first axial fan, a second axial fan, and a motor configured to drive rotation of the first axial fan and the second axial fan. The first axial fan and the second axial fan are configured to rotate about a rotation axis that coincides with a central longitudinal axis of the passageway. The airflow generation device includes a knob extending from the housing. The airflow generation device includes a blower attachment and a vacuum attachment configured to interchangeably couple to the housing and/or the fan assembly at the rear end of the housing. The fan assembly is rotatable such that, in a blower configuration, the first axial fan is disposed adjacent to the first opening, and in a vacuum configuration, the second axial fan is disposed adjacent to the first opening, wherein rotation of the knob transitions the fan assembly between the first configuration and the second configuration. The airflow generating device further includes at least one poke-yoke feature configured to prevent misconnection of blower attachment and the vacuum attachment based on a configuration of the fan assembly.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a side view of a blower/vacuum in a blower mode in accordance with embodiments of the present disclosure;

FIG. 2 is a side cross-sectional view of a blower/vacuum in a vacuum mode in accordance with embodiments of the present disclosure;

FIG. 3 is a side cross-sectional view of a fan assembly of a blower/vacuum in accordance with embodiments of the present disclosure;

FIG. 4 is a perspective view of a fan assembly of a blower/vacuum in accordance with embodiments of the present disclosure;

FIG. 5 is a partial cross-sectional view of a fan assembly of a blower/vacuum in accordance with embodiments of the present disclosure;

FIG. 6A is a side view of a vacuum attachment of the blower/vacuum in accordance with embodiments of the present disclosure;

FIG. 6B is a perspective view of an attachment arm of the vacuum attachment of FIG. 6A;

FIG. 7A is a perspective view of a blower attachment of the blower/vacuum in accordance with embodiments of the present disclosure;

FIG. 8A is a top view of a fan-side attachment mechanism in accordance with embodiments of the present disclosure;

FIG. 8B is a side view of the fan-side attachment mechanism of FIG. 8A;

FIG. 9 is a perspective view of the handle assembly of a blower/vacuum in accordance with embodiments of the present disclosure;

FIG. 10A is another perspective view of a handle assembly of a blower/vacuum in accordance with embodiments of the present disclosure;

FIG. 10B is a cross-sectional view of a push-button assembly of a handle assembly of a blower/vacuum in accordance with embodiments of the present disclosure;

FIG. 11 is a cross-sectional view of a trigger assembly of the blower/vacuum in accordance with embodiments of the present disclosure;

FIG. 12 is a cross-sectional view of a printed circuit board assembly (PCBA) mounted within a blower/vacuum in accordance with embodiments of the present disclosure;

FIG. 13 is a schematic illustration of the electronic components of a blower/vacuum in accordance with embodiments of the present disclosure.

FIG. 14A is a bottom view of a housing of a blower/vacuum to illustrate motor cooling intake/exhaust in accordance with embodiments of the present disclosure;

FIG. 14B is a side view of a housing of a blower/vacuum to illustrate motor cooling intake/exhaust in accordance with embodiments of the present disclosure;

FIG. 15 is a perspective view of a harness support for use with a blower/vacuum in accordance with embodiments of the present disclosure; and

FIG. 16 is a side view of a blower/vacuum having an alternative vacuum collection bag in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

As used herein, the term “poke yoke,” a Japanese term that means “mistake-proofing” or “inadvertent error prevention,” means a feature that either makes it impossible for an error to occur or makes the error immediately obvious once it has occurred.

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, an airflow generating tool, e.g., a blower/vacuum, includes a fan assembly including a counter-rotating fans unit having first and second axial fans. The fan assembly can be transitioned between a blower configuration and a vacuum configuration, e.g., by rotation of a knob on a housing of the blower/vacuum. The blower/vacuum can include interchangeable blower and vacuum attachments. The blower attachment, vacuum attachment, and fan assembly can have one or more poke-yoke features configured to prevent misconnection of the blower attachment and vacuum attachment.

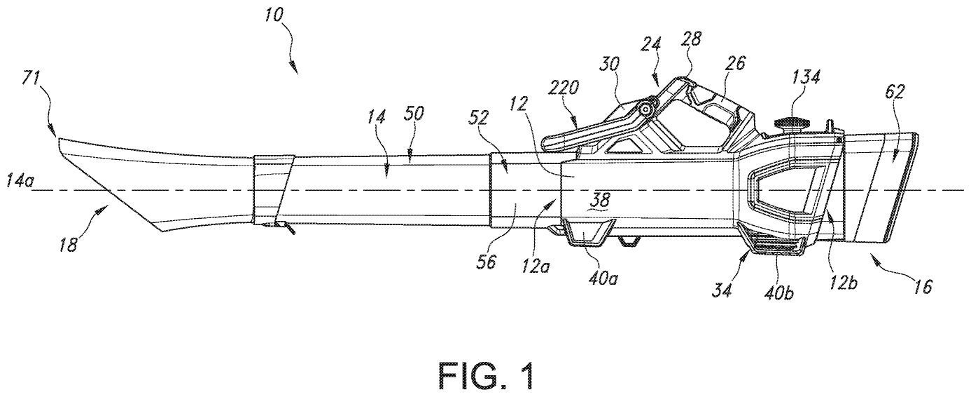

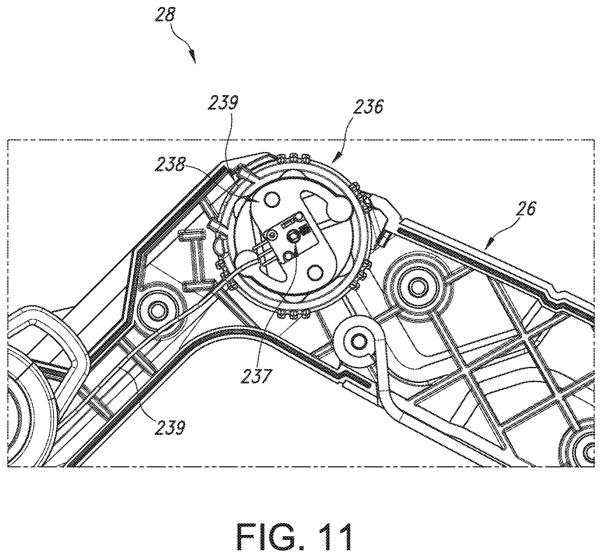

FIGS. 1-13 generally illustrate an outdoor tool, such as an airflow generating device (e.g., a blower, a vacuum and/or a mulcher), and an adjustable fan assembly for such tool. The fan assembly is adjustable (e.g., pivotable) to change a direction of air flow in the tool. With the adjustable fan assembly, the tool may provide a combination blower and mulcher/vacuum (e.g., a blower/vacuum 10).

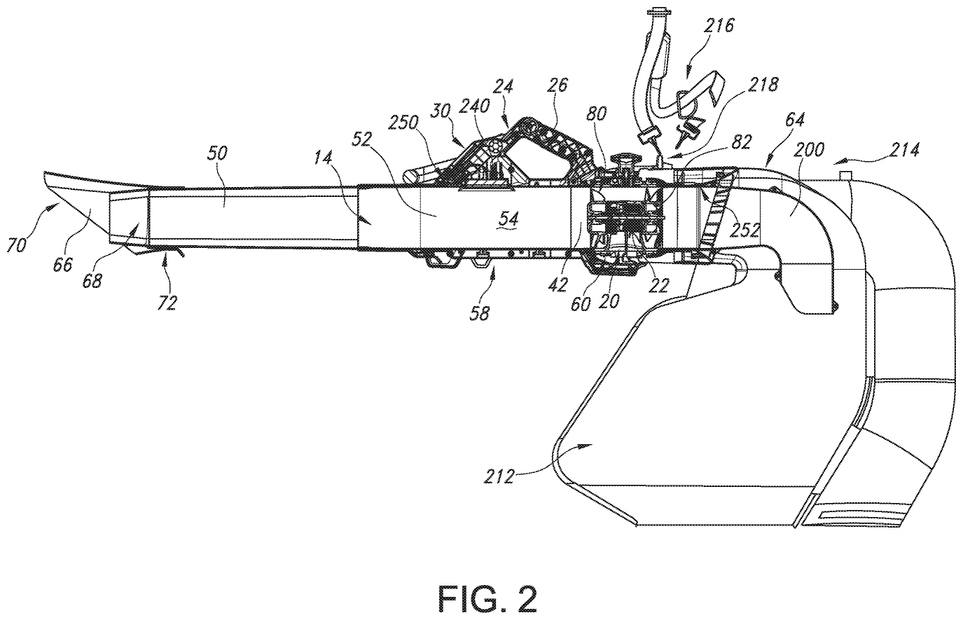

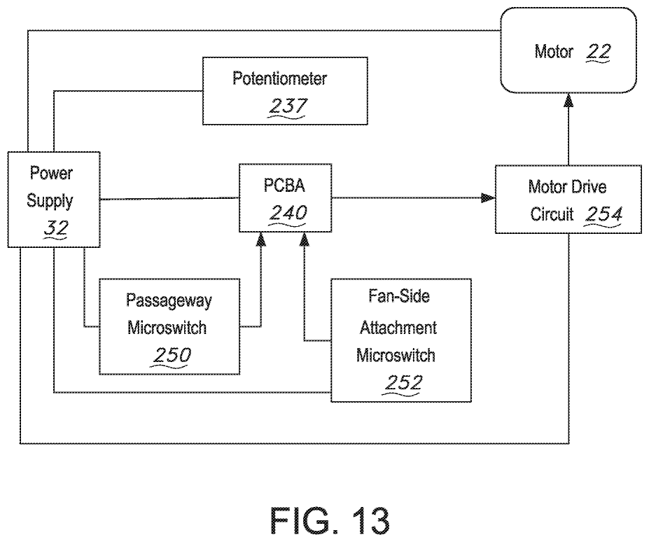

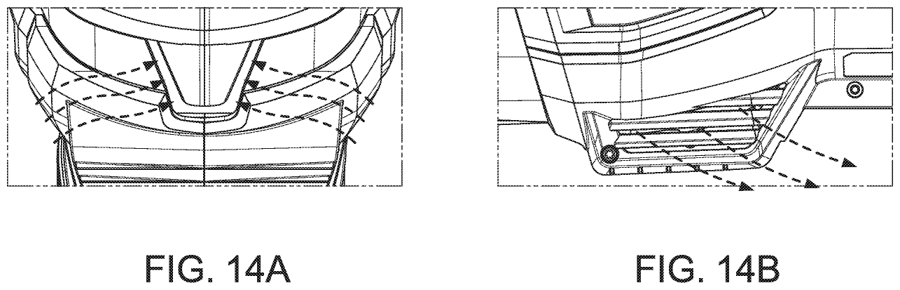

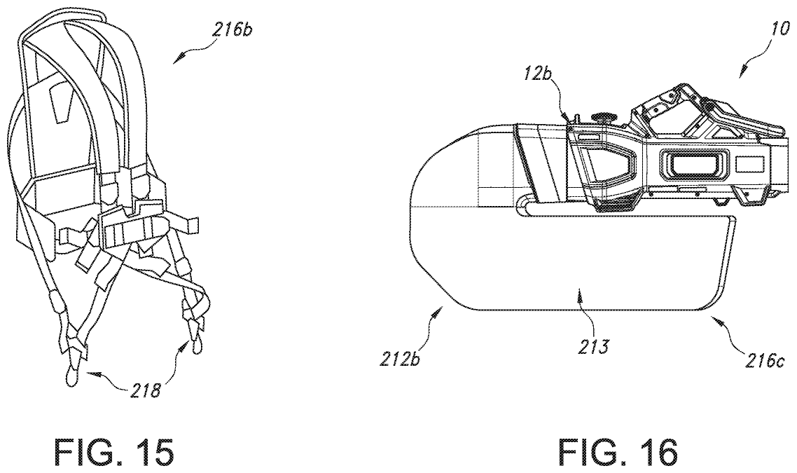

As shown in FIG. 1, the blower/vacuum 10 includes a housing 12 extending from a front end 12a to a rear end 12b and enclosing at least a portion of a passageway 14. The passageway may extend along a central longitudinal axis 14a from a first end 16 to a second end 18. The housing 12 supports a fan assembly 20 including a drive motor 22 assembled in the interior of the passageway 14 (see FIG. 2). The housing 12 may further include a handle assembly 24 extending above the passageway 14 and including a grip 26 having a trigger assembly 28 operably connected to the drive motor 22. The housing 12 can further include a battery receptacle 30, e.g., for receiving a battery 32 (schematically shown in FIG. 13) as an electrical power source for the motor 22. Additionally, the housing 12 can include one or more openings 34 configured to enable intake and/or exhaust airflow for cooling the motor 22.

The housing 12 can include a right housing portion 36 and a left housing portion 38 coupled by one or more fasteners or inter-engaging members (not shown). The grip 26 can be formed from both the right housing portion 36 and the left housing portion 38. The housing 12 can further include one or more feet 40 on a bottom side of the housing 12 that are configured to support the blower/vacuum 10 when the blower/vacuum 10 is placed on a surface. In some embodiments, the feet 40 can be formed from both the right housing portion 36 and the left housing portion 38. For instance, the feet 40 can include a forward foot 40a and a rear foot 40b. In some embodiments, one or more of the openings 34 can be formed in a surface of a rear foot 40b, e.g., a side surface as shown in FIG. 1.

As shown in cross-section in FIG. 2, the passageway 14 may include a substantially cylindrical forward passageway section 50 and a rear passageway section 52. The rear passageway section 52 can include a first half 54 and a second half 56 coupled by fasteners and/or inter-engaging members (not shown). The rear passageway section 52 may have an elongated tubular section 58 that is substantially cylindrical and a bulbous section 60 at the rear end of the rear passageway section 52 that is configured to enclose the fan assembly 20. Both the forward passageway section 50 and the rear passageway section 52 may have a generally circular cross-sectional shape at each end.

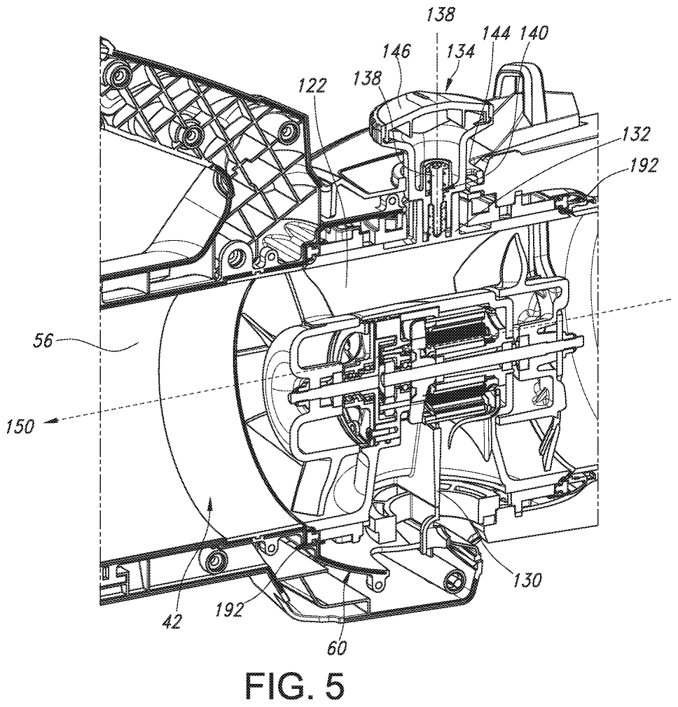

A reinforcing ring 42 (shown in FIG. 5) can be provided within the elongated tubular section 58 of the rear passageway section 52 to provide impact resistance against the impact from debris. For instance, the reinforcing ring 42 can be positioned within the elongated tubular section 58 and adjacent to the bulbous section 60. The reinforcing ring 42 can be formed from any suitable material, including but not limited to ultra-high molecular weight polyethylene. By providing the reinforcing ring 42 adjacent to the bulbous section 60, which, as described in further detail below, contains the fan assembly 20, the rear passageway section 52 can have added impact resistance to debris, such as rocks, that are picked up during a vacuum operation but cannot pass through the fan assembly 20.

Opposite the fan assembly 20 from the rear passageway section 52, the blower/vacuum 10 can include one or more attachments configured to be received by the housing 12, the fan assembly 20 and the rear passageway section 52 at the first end 16 of the passageway. A blower attachment 62 (shown in FIG. 1) can be provided for use during a blower operation of the blower/vacuum 10. A vacuum attachment 64 (shown in FIG. 2) can be provided for use during a vacuum operation of the blower/vacuum 10. As will be described in further detail below, the fan assembly 20, blower attachment 62 and vacuum attachment 64 can include various features configured to prevent misuse of the blower/vacuum 10, i.e., so that the blower/vacuum 10 cannot be operated in a vacuum operation when the blower attachment 62 is attached to the fan assembly 20, and the blower operation cannot be initiated when the vacuum attachment 64 is attached to the fan assembly 20.

Additionally, as shown in FIG. 2, the blower/vacuum 10 can include a vacuum nozzle 66 configured to be coupled to the forward passageway section 50. The vacuum nozzle 66 can form an extension of the passageway 14 and may have a circular opening 68 configured to couple with the forward passageway section 50 and a flared opening 70 at an opposite end. The flared opening 70 can aid in debris pickup during a vacuum operation of the blower/vacuum 10. The flared opening 70 can have an elliptical shape opening or any other suitable shape. Additionally, the flared opening 70 can have a relief section 71 formed in a forward end thereof to create a gap between the nozzle 66 and the ground in order to prevent the nozzle 66 from sticking or suctioning itself to the ground. The vacuum nozzle 66 can be coupled to the forward passageway section 50 by any suitable means. In one embodiment, a clip 72 may be provided near the circular opening 68 for insertion into a receiver 74 of the forward passageway section 50.

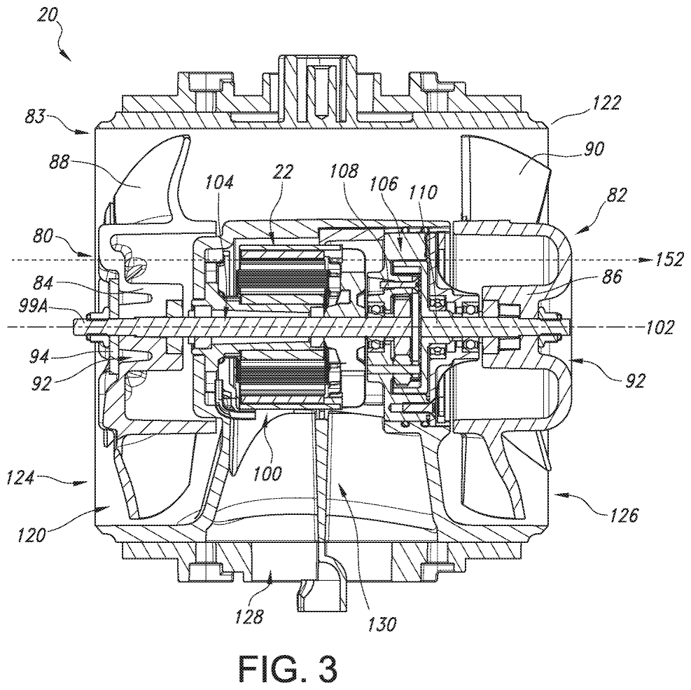

Referring to FIGS. 2 and 3, the blower/vacuum 10 includes a fan assembly 20 assembled in the interior of the passageway 14. In particular, the fan assembly 20 can be assembled in the interior of the bulbous section 60 of the rear passageway section 52 as stated above. The fan assembly 20 includes a first axial fan 80 and a second axial fan 82 positioned inside a fan assembly housing 83 and operable to rotate around the passageway axis 14a to generate an airflow in the passageway 14. Each fan 80, 82 has a hub 84, 86 with a rounded shape. First blades 88 and second blades 90 extend radially outwardly from the first hub 84 and the second hub 86, respectively. As shown in FIG. 3, the first blades 88 and the second blades 90 extend outwardly from a hollow cylindrical portion 92 of the hubs 84, 86, respectively.

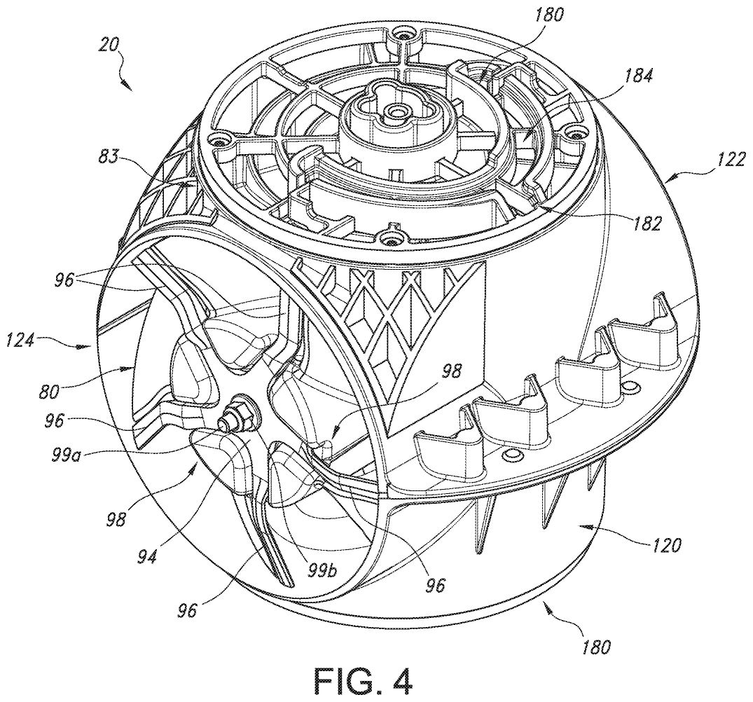

In the illustrated embodiment, the first axial fan 80 may be a vacuum fan and the second axial fan 82 may be a blower fan. The first axial fan 80, i.e., the vacuum fan, may include a mulch blade 94, as shown in FIG. 4. The mulch blade 94 can be formed from metal, such as but not limited to steel, and can have at least one sharp blade edge. The mulch blade 94 can be disposed on a leading edge of the first axial fan 80, i.e., opposite the first axial fan 80 from the second axial fan 82. The mulch blade 94 can include one or more arms 96 extending outwardly from slots 98 in the hub 84 of the first axial fan 80 to form sharp bladed edges. For instance, the first axial fan 80 can include an equal number of first blades 88 and arms 96, e.g., five first blades 88 and five arms 96 as shown in FIG. 4, or any other suitable number. The arms 96 can be arranged to be disposed on a leading edge of each of the first blades 88, respectively. As will be described in further detail below, the mulch blade 94 can be driven to rotate about a rotation axis that coincides with the longitudinal axis 14a. For instance, the mulch blade 94 can be coupled with the first axial fan 80, e.g., along a shaft 99a and coupled with a fastener 99b such as a nut. The shaft 99a can be coupled to a rotating shaft of the first axial fan 80 so that the mulch blade 94 may rotate together with the first axial fan 80. For instance, the shaft 99a may be the rotating shaft of the first axial fan 80. The arms 96 of the mulch blade 94 can have a pitch in the same direction as a pitch of the first blades 88. During a vacuum operation of the blower/vacuum 10, the blower/vacuum 10 may achieve a 16:1 mulching ratio, i.e., 16 bags of dried leaves could be mulched down to one bag after vacuuming with the blower/vacuum 10.

Turning back to FIG. 3, the fan assembly 20 further includes a motor 22 configured to drive rotation of the first axial fan 80 and the second axial fan 82. The motor 22 may be mounted within the fan assembly housing 83. For instance, the fan assembly housing 83 may include a motor mount 100 configured to support the motor 22 within the passageway 14. The motor 22 is oriented along a motor axis 102. The motor axis 102 coincides with the central axis 14a of the passageway 14. Rotation of the motor 22 causes rotation of a primary motor shaft 104 extending along the motor axis 102. The primary motor rotation shaft 104 extends from the first axial fan 80 to a transmission gearbox 106. In this manner, rotation of the primary motor shaft 104 causes rotation of the first axial fan 80, as the first axial fan 80 is mounted to the primary motor shaft 104. At the gearbox 106, one or more driven gears 108 are provided to define a gear set.

A secondary shaft 110 is provided at the gearbox 106 to mesh with the drive gears 108. The secondary shaft 110 extends along the motor axis 102 from the gearbox 106 to the second axial fan 82. The second axial fan 82 is mounted to the secondary shaft 110 such that rotation of the secondary shaft 110 causes rotation of the second axial fan 82.

The driven gears 108 cause the secondary shaft 110 to rotate in an opposite direction from the primary motor shaft 104. In this configuration, rotation of the primary motor shaft 104 in one direction, e.g., clockwise, will cause the secondary shaft 110 to be driven in an opposite direction, e.g., counter-clockwise. Rotation of the primary motor shaft 104 and the secondary shaft 110 in opposite directions causes the first axial fan 80 and the second axial fan 82 to counter-rotate (i.e., rotate in opposite directions with respect to one another).

The gearbox 108 and the drive gears 108 rotate the secondary shaft 110, and thereby, the second axial fan 82, at a 2:1 speed reduction. In other words, the second axial fan 82 rotates at half the speed as the primary axial fan 80 and the primary motor shaft 104. Because the second axial fan 82 operates at a much lower speed than the first axial fan 80 (i.e., half speed), the second axial fan 82 consumes much less power than the first axial fan 80. As a result, the counter-rotating fans unit of the fan assembly 20 has improved efficiency. Additionally, the gears 108 of the gearbox 106 can be reduced in size because they are required to handle less power (i.e., one half of the power required to rotate the first axial fan 80).

The fan assembly housing 83 can be formed from one or more pieces. For instance, the fan assembly housing 83 can be formed from a lower housing 120 and an upper housing 122. The fan assembly housing 83 can have a shape formed by two generally intersecting cylindrical portions. For instance, a horizontal cylindrical shape can extend generally along the direction of the passageway 14 and a vertical cylindrical shape can bisect the horizontal cylindrical shape in an up-and-down direction. The fan assembly housing 83 can have a substantially circular shape first fan opening 124 formed from both the lower housing 120 and upper housing 122 and a substantially circular shape second fan opening 126 opposite the first fan opening 124 and formed from both the lower housing 120 and upper housing 122. Moreover, the lower housing 120 can include a lower cooling opening 128 configured to allow intake or exhaust of cooling airflow to/from the motor 22. The lower cooling opening 128 can include an airflow separation rib 130 extending in a vertical direction to guide airflow to and from the motor 22 and to separate the cooling intake flow from the motor cooling exhaust airflow, as will be described in further detail below. The upper housing 122 can include a receiving opening 132 at a top central section of the upper housing 122 that is configured to receive a knob 134.

As shown in FIGS. 3-4, an adjustment assembly is operable to adjust (e.g., rotate) the fan assembly 20 to change a direction of air flow in the passageway 14. The adjustment assembly includes an actuator coupled (e.g., positively and/or frictionally) to the fan assembly housing 83 opposite the lower housing 120 for movement therewith.

In the illustrated embodiment, the adjustment assembly includes a knob 134 that can be used to rotate the fan assembly 20 about a rotation axis 136 that is perpendicular to the axis 14a of the passageway 14. The knob 134 can include a shaft 138 configured to be received in the receiving opening 132 of the upper housing 122, a spring 140, and a main body 142. The main body 142 of the knob 134 can include an elongated section 144 surrounding the shaft 138 and the spring 140. The elongated section 144 can extend in a direction perpendicular to the passageway 14. The main body 142 of the knob 134 can further include a head 146 configured to protrude upward from the bulbous section 60 of the rear passageway section 52 and be gripped and rotated by a user. The position of the knob 134 defines a condition or configuration of the blower/vacuum 10.

In one condition (e.g., a blower condition, as illustrated in FIG. 5), the first axial fan 80 is directed towards a first end 16 of the passageway 14 and the second axial fan 82 is directed towards a second end 18 of the passageway 14. In this condition, the first axial fan 80 draws air into the passageway 14 through an opening at the first end 16, and the second axial fan 82 pushes air out of the passageway 14 through the second end 18. This defines a first air direction 150 from the first end 16 to the second end 18. In this condition, the knob 134 is rotated in a counter-clockwise direction.

The knob 134 is rotatable 180 degrees about an axis defined by the main body 142 of the knob 134, i.e., perpendicular to the passageway 14, to a second condition (e.g., a vacuum or mulcher condition, as shown in FIG. 3) of the blower/vacuum 10. In this condition, the first axial fan 80 is directed towards the second end 18 of the passageway 14, and the second axial fan 82 is directed towards the first end 16 of the passageway 14. In this condition, the first axial fan 80 draws air into the passageway 14 through the second end 18, and the second axial fan 82 pushes air out of the passageway 14 through the first end 16. This defines a second air direction 152 from the second end 18 to the first end 16. In this condition, the knob 134 is rotated in a clockwise direction.

The knob 134 can rotate in either a clockwise or counter-clockwise direction to switch between the blower condition and the vacuum condition, or, if desired, to dispose the blower/vacuum in a transition mode that is not in the blower condition or the vacuum condition. To rotate the knob 134, the head 146 is pulled up away from a locked position, i.e., away from the upper housing 122 of the fan assembly 20, thereby compressing the spring 140. The knob head 146 can then be rotated clockwise or counter-clockwise and released when the fan assembly 20 is in the desired configuration. The knob 134 and/or the upper housing 122 may be provided with one or more ribs 148 to limit rotation of the knob 134 to 180 degrees. By limiting the rotation of the knob 134 to 180 degrees, any wires inside the fan assembly housing 83 can be prevented from tangling or twisting as compared to if the fan assembly 20 could rotate 360 degrees.

In alternate embodiments (not shown), the knob 134 can rotate more than 180 degrees (e.g., 360 degrees or more) between the configurations. In still other embodiments (not shown), the blower/vacuum 10 may be constructed so that the knob 134 pivots less than 180 degrees between the conditions.

In a blower condition (FIG. 5), air flows out of the second end 18 and into the environment outside of the passageway 14. This flow of air contacts debris (e.g., leaves) proximate the second end 18 and directs them along the first air direction 150. In the vacuum condition (FIG. 4), air flows into the second end 18 from the environment outside the passageway 14. This flow of air suctions debris (e.g., leaves) proximate the second end 18 and directs them along the second air direction 152, i.e., through the passageway 14.

In the vacuum condition, debris that enters the passageway 14 passes through and is contacted by the mulch blade 94. The sharp bladed edges of the arms 96 of the mulch blade 94 can chop or break up debris into smaller pieces. The debris passes through the first end 16 after it passes through the first axial fan 80 and the second axial fan 82. A collector (e.g., a bag or other container) can be coupled to the first end 16 to retain the broken-up debris, as described in further detail below.

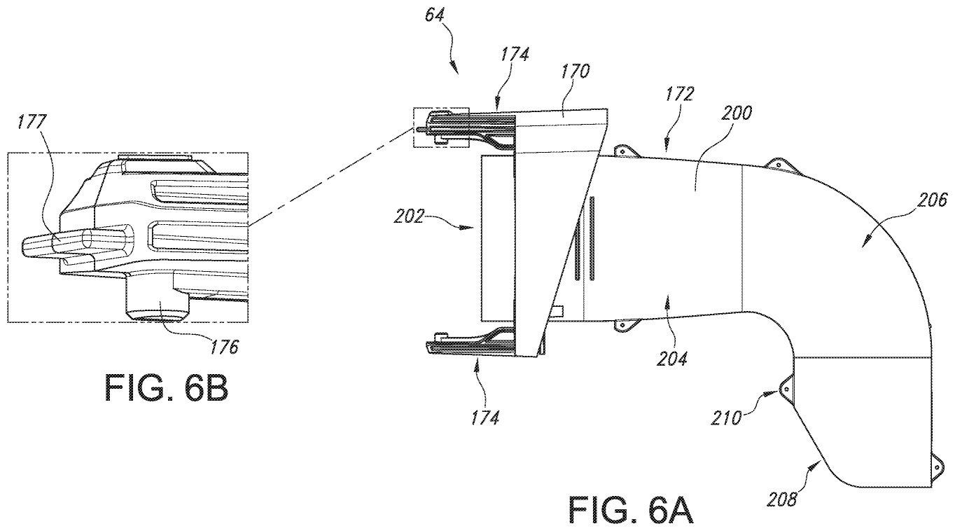

Turning now to FIGS. 6A-B and 7A-B, the blower/vacuum 10 can include both a blower attachment 62 and a vacuum attachment 64 for interchangeably coupling to the fan assembly 20 adjacent the first end 16 of the passageway 14. Additionally, the fan assembly 20 can be provided with a fan-side attachment mechanism that couples to the blower attachment 62 or the vacuum attachment 64.

As illustrated in FIGS. 6A-B, the vacuum attachment 64 includes a vacuum attachment coupling body 170 surrounding a dirt redirecting piece 172. The vacuum attachment coupling body 170 includes coupling features, e.g., upper and lower attachment arms 174 extending from the vacuum attachment coupling body 170 in the direction of the passageway 14, e.g., parallel to the passageway 14. The upper and lower attachment arms 174 can each include a pin 176 extending in a radial direction configured to couple with the fan-side attachment mechanism, described in further detail below. At least one of the attachment arms 174, e.g., the upper attachment arm as illustrated in FIG. 6A, can further include an alignment projection 177 configured for insertion into an aligning opening (not shown) of the housing 12 or the fan assembly housing 83. For instance, the alignment projection 177 can extend in a direction parallel to the axis 14a, e.g., generally perpendicular to the radially extending pin 176.

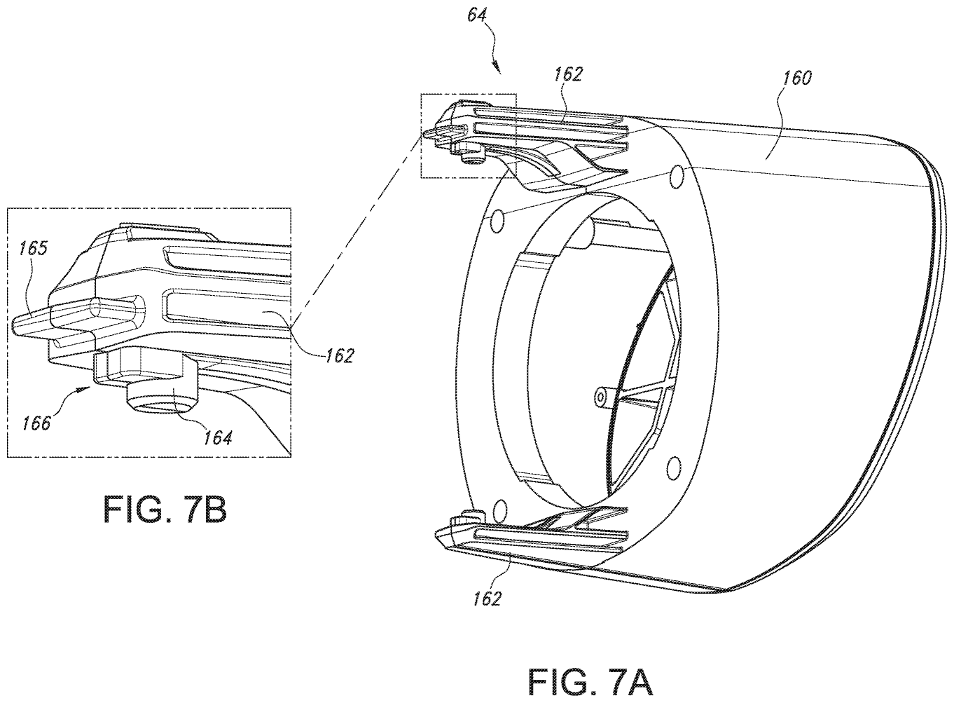

As illustrated in FIGS. 7A-B, the blower attachment 62 includes a blower tube body 160 and coupling features, e.g., upper and lower attachment arms 162 extending from the blower tube body 160 in the direction of the passageway 14, e.g., parallel to the passageway 14. The upper and lower attachment arms 162 can each include pin 164 extending in a radial direction configured to couple with the fan-side attachment mechanism, described in further detail below. At least one of the attachment arms 162, e.g., the upper attachment arm as illustrated in FIG. 7A, can further include an alignment projection 165 configured for insertion into an aligning opening (not shown) of the housing 12 or the fan assembly housing 83. For instance, the alignment projection 165 can extend in a direction parallel to the axis 14a, e.g., generally perpendicular to the radially extending pin 164. Moreover, the upper and lower attachment arms 162 can each include a stop 166 configured to prevent misconnection with the fan-side attachment mechanism to ensure that the blower/vacuum 10 is engaged in the blower configuration when the blower attachment 62 is coupled to the passageway 14.

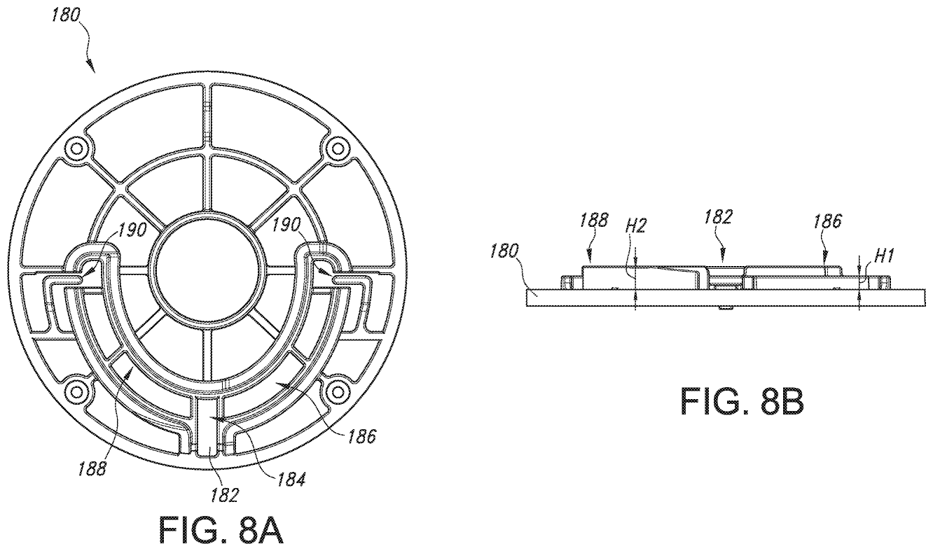

The fan-side attachment mechanism, e.g., as shown in FIG. 4 and FIG. 8, includes a circular track 180 provided on one or both of the upper housing 122 and the lower housing 120 of the fan assembly housing 83 and configured to receive the pins 164, 176. The track 180 includes an entry track section 182 configured to be aligned with, e.g., parallel to, the passageway 14 when the fan assembly 20 is in the transition mode. The entry track section 182 intersects with a circular track section 184 that extends about 180 degrees, and the entry track section 182 generally bisects the circular track section 184 such that the fan-side attachment mechanism can be rotated about 90 degrees clockwise and counter-clockwise (i.e., by rotating the knob 134 as described above) from the entry track section 182. The circular track 180 can further include one or more locking features configured to lock the pins 164, 176 in place when fully coupled to the fan assembly 20 in the blower configuration or vacuum configuration. In the illustrated embodiment, the locking features include a spring arm 190 provided at each end of the circular track section 184. The spring arm 190 can be configured to engage the pins 164, 176 to hold each pin in place.

The attachments 62, 64 and the circular track 180 can be provided with one or more poke yoke features to prevent the incorrect attachment from being installed in the incorrect mode. For instance, in the illustrated embodiment, the circular track section 184 can be defined by ribs having a height protruding from the track. The blower section 186 of the circular track section 184 can have a rib or raised wall with a height H1 and the vacuum section 188 of the circular track section 184 can have a height H2. The height H2 of the vacuum section 188 can be higher than the height H1 of the blower section 186. As described above, the attachment arms 162 of the blower attachment 62 can include a stop 166, e.g., adjacent to the pin 164. Because the vacuum section 188 has a height H2 that is greater, the stop 166 would collide with the raised wall of the vacuum section 188 and prevent rotation in the direction of the vacuum section 188. As a result, the pin 164 of the blower tube attachment arms 162 can only enter the blower section 186 of the track 180. Similarly, the pin 176 of the vacuum attachment arms 174 can only enter the vacuum track section 188. This arrangement can ensure that there is a correspondence between the orientation of the first axial fan 80 and the second axial fan 82 of the counter-rotating fans unit and the type of attachment.

In some aspects of the present invention, the fan-side attachment mechanism, e.g., circular track 180, can be molded, e.g., from a single piece. The spring arms 190 can be molded in a one-piece construction with the circular track 180. For example, the circular track 180 can be coupled to the fan assembly housing 83 by using fasteners or any other suitable coupling mechanism.

In some aspects of the present invention, one or more seals 192 can be provided around the fan assembly 20. For instance, a seal 192 can surround, e.g., encircle, at least one circular track 180 of the fan assembly 20, e.g., both the circular tracks 180 on the upper housing 122 and lower housing 120 respectively. One or more additional seals 192 (illustrated in FIG. 5) can be provided around the fan assembly housing 83 as desired. Each seal 192 can provide support to aid in preventing misalignment of the fan assembly 20, e.g., misalignment with either of the attachments 62, 64 or misalignment with the knob 134. Additionally or alternatively, each seal 192 can aid in preventing dust or debris from entering the housing 12 above and below the fan assembly 20.

As shown in FIGS. 6A-B, the vacuum attachment 64 includes a vacuum attachment coupling body 170 surrounding a dirt redirecting piece 172. The attachment coupling body 170 can be coupled to the dirt redirecting piece 172 by any suitable means. In the illustrated embodiment, a shoulder bolt 194 surrounded by a spring 196 can be inserted within a receiving hole 198 of the vacuum attachment coupling body 170. The dirt redirecting piece 172 further includes a tubular body 200 coupled to the attachment coupling body 170 at a first end of the tubular body 200. During attachment of the vacuum attachment 64 to the fan assembly 20, as the vacuum attachment 64 is coupled and the fan assembly 20 is rotated into place, the shoulder bolt 194 may contact the circular track 180 or the fan assembly housing 83. As this contact begins, the spring 196 may be compressed, thereby allowing the tubular body 200 of the dirt redirecting piece 172 to move or rotate as needed. Once the vacuum attachment 64 is fully in place and the fan assembly 20 is rotated into the vacuum configuration, the spring 196 will push the elongated tubular body 200 flush with the fan assembly 20 to seal airflow between the fan assembly 20 and the elongated tubular body 200, thereby preventing debris or dirt from entering the housing 12 surrounding the fan assembly 20.

As shown in FIG. 6A, the dirt redirecting piece 172 includes a tubular body 200. The tubular body 200 comprises an elongated section 204 extending from the first end 202 and an angled section 206 extending from a second end 208 opposite the first end 202. The elongated section 204 of the tubular body 200 can have a circular cross section. The angled section 206 of the tubular body can have an elliptical cross section. At the angle 210 of the tubular body 200, the tubular body 200 transitions from the circular cross section to the elliptical cross section while maintaining the same cross-sectional area. Stated differently, the cross-sectional area at the first end 202 and at the second end 208 of the tubular body 200 can be equal while the cross-sectional shapes at the first end 202 and at the second end 208 of the tubular body 200 can be different. The present inventors have found that the shape of the illustrated embodiment of the tubular body 200 can enable the tubular body 200 to have as short as possible of a length from the first end 202 to the second end 208, so as to pass a finger prove safety test, while effectively redirecting the dirt and debris vacuumed by the blower/vacuum 10 operating in a vacuum mode.

Further, as shown in FIG. 2, the vacuum attachment 64 can include a bag, container, or other debris collector, e.g., vacuum bag 212, configured to receive and contain the debris vacuumed during a vacuum operation of the blower/vacuum 10. For instance, the dirt redirecting piece 172 can be releasably coupled to a vacuum bag 212 at the second end 208 of the tubular body 200. As shown in FIG. 2, the vacuum bag 212 can further include an exhaust port 21 configured to release exhaust air that is separated from the dirt redirect 172. As illustrated in FIG. 2, in a vacuum configuration, the elongated section 204 of the tubular body 200 can extend generally coaxially with the passageway 14, and the angled section 206 can extend downward to the vacuum bag 212.

The vacuum bag 212 can be formed from a fabric, e.g., ripstop fabric, or any other suitable material. The bag 212 can include one or more side panels 213 to shield the user from getting debris on them. In some aspects of the present invention, the bag 212 can form a C-shape, shown as bag 212b in FIG. 16, with the blower/vac 10 such a distal portion 216c that the bag 212b curves below the fan assembly 20, in order to bring the center of gravity of the vacuumed debris forward in order to optimize balance for the user. The vacuum bag 212 can include at least one filter (not shown) disposed within the bag 212 that can allow airflow through the filter towards the exhaust port 21 while preventing debris from exiting the bag 212. The filter can be formed from a filter fabric or any other suitable filter material. The vacuum bag 212 can include at least one attachment point, e.g., a hook or clip 214, configured to couple with a support 216 (e.g., a harness and/or a strap) to enable the vacuum bag 212 to be supported by the user and/or on the housing 12 of the blower/vacuum 10. The hook or clip 214 can be spaced apart from the second end 208 of the tubular body 200. For instance, a C-shaped bag 212 can include one or more clips near a distal end of the bag 212 configured to be coupled to a bottom portion of the housing 14.

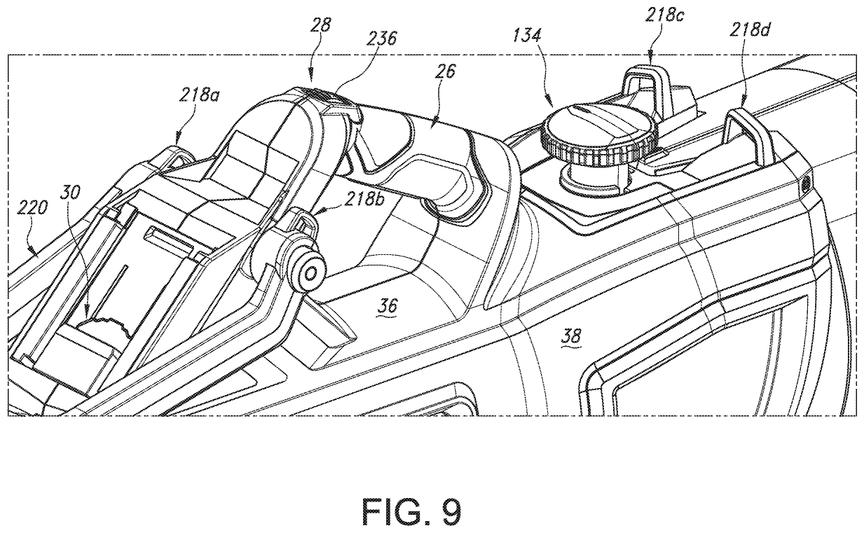

Turning back to the housing 12 of the blower/vacuum 10, as shown in FIG. 9, the housing 12 can include one or more hooks or clips 218 configured to couple with a support 216, e.g., a strap and/or a harness, to further support the blower/vacuum 10 on the user. For instance, the housing 12 can include a plurality of hooks or clips 218. In the illustrated embodiment, the housing 12 includes a front right clip 218a, a front left clip 218b, a rear right clip 218c, and a rear left clip 218d. The front right clip 218a and the front left clip 218b can be positioned forward of the fan assembly 20, e.g., forward of the grip 26 as shown. The rear right clip 218c and the rear left clip 218d can be provided adjacent the first end 16 of the passageway 14 and may be positioned behind the knob 134 as shown. By providing clips on both sides of the housing 12, the weight of the blower/vacuum 10 can be evenly distributed about the longitudinal axis. In some aspects of the invention, the housing 12 may be provided only with clips toward the rear of the blower/vacuum, e.g., rear right clip 218c and rear left clip 218d, to couple with a user support harness. In this arrangement, the weight of the blower/vacuum 10 may be more comfortably distributed via the harness 216 to the user by not pulling the user forward towards any forward clips. Additionally or alternatively, the housing 12 can include one or more clips 218 extending along a center longitudinal axis of the housing 12 (not shown).

As shown in FIGS. 1-2 and 9, the handle assembly 24 can include a grip 26. The grip 26 can be disposed above the passageway 14 and forward of the fan assembly 20. The handle assembly 24 can further include a support handle 220. In the illustrated embodiment, the support handle 220 is disposed forward of the grip 26. The support handle 220 can be pivotably coupled to the housing 12. The support handle can include a support grip 222 and support arms 224 on either side of the support grip 222. The support arms 224 can couple to the housing 12 by suitable coupling means. For instance, a pivoting assembly 226 can be provided on one or both support arms 224 to pivotably couple the support arms 224 to the housing 12. Each pivoting assembly 226 can include a detent lock 228 including multiple locking positions and a push button 230 coupled to the support arms 224. When the push button 230 is compressed toward the housing 12, the detent lock is disengaged and the support arms 224 can be rotated up or down. When the push button 230 is released, the support arms 224 lock in place via the detent lock 228. The detent lock 228 can include one or more travel limiting ribs and/or a hard stop to limit the range of rotation or pivoting of the support arms 224.

Additionally, in the illustrated embodiment, the front clips 218a, 218b can be provided on ends of the support arms 224 as shown.

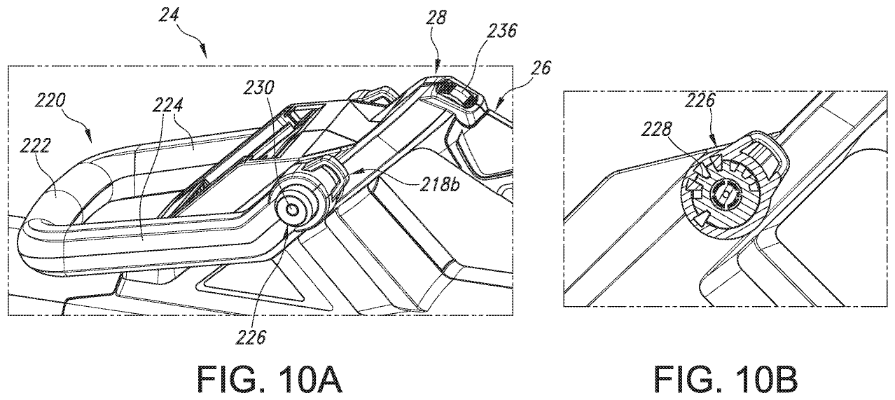

The housing 12 can further include a battery receptacle 30 configured to receive a power supply, e.g., a battery 32. The battery receptacle 30 can include an electrical coupling 234 configured to electrically couple the battery to a control assembly, e.g., a printed circuit board assembly (PCBA) 240 as described in further detail below. In the illustrated embodiment, the battery receptacle 30 can be disposed on the front of the housing 12, e.g., forward of the grip 26 of the handle assembly 24. For instance, as shown in FIGS. 9 and 10A, the support handle 220 can extend on either side of the battery receptacle 30. In the illustrated arrangement, the support handle 220 can pivot unobstructed on either side of the battery. In some aspects of the present invention, if the battery includes a battery indicator, the positioning of the battery on the front of the housing 12 as shown can enable a user to quickly and easily gauge the amount of battery remaining while the blower/vacuum 10 is in use.

Moreover, the positioning of the battery in the battery receptacle 30 on the front of the housing 12 can allow the center of gravity of the blower/vacuum 10 to be well balanced with the fan assembly 20 towards the rear of the blower/vacuum 10.

The trigger assembly 28 can be disposed on the handle assembly 24 forward of the grip 26. The trigger assembly 28 can include a speed dial 236 configured to control the speed of the motor 22. The speed dial 236 can include a potentiometer 237 containing an on/off switch. The speed dial 236 may be mounted to a hinge 238 comprising one or more detents 239 configured to hold the speed dial 236 in specific locations or orientations, thereby allowing the blower/vacuum 10 to operate at a constant speed without a user being required to hold the speed dial 236 in place. The potentiometer is coupled to the PCBA 240, e.g., by wires or cables 239, to control the speed of the motor 22.

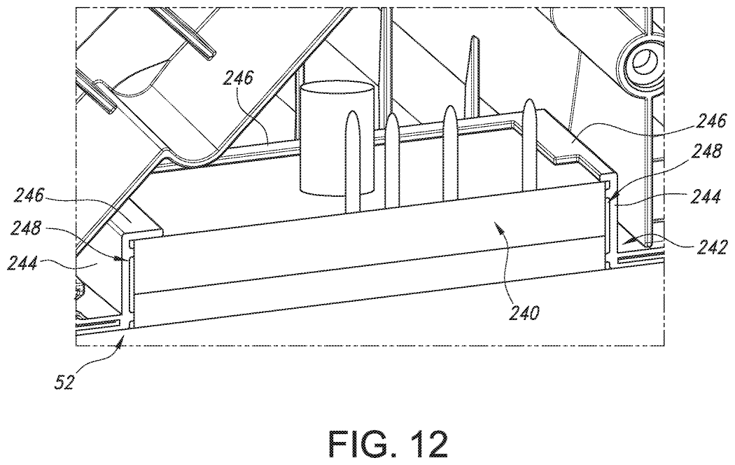

The PCBA 240 can be enclosed within the housing 12 and coupled to the speed dial 236 and the motor 22 to control the operation of the blower/vacuum 10. For instance, as illustrated, the PCBA 240 can be mounted to an exterior of the rear passageway section 52, e.g., beneath the battery receptacle 30 mounted on the housing 12. The PCBA 240 includes a heat sink (not shown) that extends through the rear passageway section 52 and is disposed within the passageway 16 for cooling. In this manner, the heat sink of the PCBA 240 can be cooled by the vacuum or blowing airflow. As shown in FIG. 12, the PCBA 240 can be mounted in a PCBA mount 242 that may include side walls 244 extending around side surfaces of the PCBA 240 and one or more stop walls 246 configured to hold the top surface of the PCBA 240 in place. In some aspects of the present invention, one or more rubber isolators 248 can be provided to isolate and separate the PCBA 240 from the passageway 14 and the housing 12. For instance, one or more rubber isolators 248 can be disposed between side surfaces of the PCBA 240 and the side walls 244 of the PCBA mount 242. The rubber isolator(s) 248 can be configured to isolate the PCBA from vibrations of the housing 12 due to the rotation of the motor 22 and axial fans 80, 82. Additionally, the rubber isolator(s) 248 can seal the PCBA 240 from the passageway 16, e.g., around the opening into the rear passageway section 52, to prevent dirt from getting into the PCBA 240 or other parts of the housing.

The blower/vacuum 10 can be further provided with one or more safety features. For instance, in one aspect of the illustrated invention, the blower/vacuum can be prevented from turning on unless the forward passageway 50 is coupled to the housing 12 and either the blower attachment 62 or the vacuum attachment 64 is coupled to the housing 12. For example, a passageway microswitch 250 can be disposed at the attachment between the housing 12 and the forward passageway 50 and configured to detect if the forward passageway 50 is installed. The passageway microswitch 250 can be electrically coupled to the PCBA 240 as schematically shown in FIG. 13. Similarly, a fan-side attachment microswitch 252 can be disposed at the fan-side attachment mechanism, e.g., circular track 180, to detect if the blower attachment 62 or the vacuum attachment 64 is installed on the blower/vacuum 10. The fan-side attachment microswitch 252 can be electrically coupled to the PCBA 240 as schematically shown in FIG. 13. By providing the microswitches 250, 252 as safety features, the blower/vacuum 10 cannot be turned on until the blower/vacuum 10 is fully assembled, i.e., forward passageway 50 is coupled to the housing 12 and either the blower attachment 62 or the vacuum attachment 64 is coupled to the housing 12.

FIG. 13 illustrates a schematic representation of the control of the blower/vacuum 10. The power supply, e.g., battery 233, is electrically coupled with the motor 22 and the PCBA 240, as well as the microswitches 250, 252 and the potentiometer 237 to provide a power supply to all aspects of the blower/vacuum 10. The potentiometer 237 is coupled to the PCBA 240 to control the speed of the motor 22 based on a user input from the speed dial 236. The PCBA 240 is coupled to a motor drive circuit 254 which controls the operation of the motor 22. The microswitches 250, 252 are coupled to the PCBA 240 to provide safety features as described above. The PCBA 240 will not enable the motor drive circuit 254 to power the motor 22 unless the microswitches 250, 252 are switched on.

Further aspects of the invention are provided by one or more of the following embodiments:

An airflow generation device includes a housing extending between a front end and a rear end. The airflow generation device includes a passageway that extends between a first opening and a second opening, and the first opening is adjacent to the rear end of the housing. The airflow generation device includes a fan assembly positioned at least partly within the housing. The fan assembly includes a first fan, a second fan, and a motor configured to drive rotation of the first fan and the second fan. The airflow generation device includes a blower attachment and a vacuum attachment configured to interchangeably couple to the housing and/or the fan assembly at the rear end of the housing. The fan assembly is rotatable such that, in a first configuration, the first fan is disposed adjacent to the first opening, and in a second configuration, the second fan is disposed adjacent to the first opening.

The airflow generating device of any one or more of the embodiments, wherein the fan assembly is configured to rotate about an axis to transition from the first configuration to the second configuration.

The airflow generating device of any one or more of the embodiments, wherein the first fan and the second fan are configured to rotate about a rotation axis that coincides with a central longitudinal axis of the passageway.

The airflow generating device of any one or more of the embodiments, further comprising a third configuration of the fan assembly in the rotation axis of the first fan and the second fan does not coincide with the central longitudinal axis of the passageway.

The airflow generating device of any one or more of the embodiments, wherein the motor is configured to rotate about a rotation axis that coincides with a central longitudinal axis of the passageway.

The airflow generating device of any one or more of the embodiments, further comprising a knob extending from the housing, wherein rotation of the knob transitions the fan assembly between the first configuration and the second configuration.

The airflow generating device of any one or more of the embodiments, wherein the motor is disposed between the first fan and the second fan.

The airflow generating device of any one or more of the embodiments, wherein the first fan is coupled to a rotation shaft of the motor, and the second fan is coupled to the rotation shaft via a secondary shaft and a gear assembly.

The airflow generating device of any one or more of the embodiments, wherein the first fan and the second fan are driven by the motor to rotate in opposite directions.

The airflow generating device of any one or more of the embodiments, wherein the second fan rotates at half the speed of the first fan.

The airflow generating device of any one or more of the embodiments, wherein the blower attachment and the vacuum attachment are each configured to correspond to one of the first configuration or the second configuration of the fan assembly.

The airflow generating device of any one or more of the embodiments, further comprising a battery housing disposed on a front side of the housing.

The airflow generating device of any one or more of the embodiments, further comprising a microswitch configured to detect the presence of the blower attachment or the vacuum attachment coupled to the housing.

The airflow generating device of any one or more of the embodiments, further comprising a first motor cooling airflow opening and a second motor cooling airflow opening; wherein, during operation of the airflow generating device in the first configuration, a first motor cooling airflow opening provides motor cooling intake airflow and a second motor cooling airflow opening provides motor exhaust airflow; and, during operation of the airflow generating device in the second configuration, the second motor cooling airflow opening provides motor cooling intake airflow and the first motor cooling airflow opening provides motor exhaust airflow.

The airflow generating device of any one or more of the embodiments, further comprising an airflow separation rib in a housing of the fan assembly provided between the first motor cooling airflow opening and the second motor cooling airflow opening.

The airflow generating device of any one or more of the embodiments, further comprising a mulch blade coupled to the first fan.

The airflow generating device of any one or more of the embodiments, wherein the blower attachment is configured to couple to the housing and/or the fan assembly in the first configuration, and the vacuum attachment is configured to couple to the housing and/or the fan assembly in the second configuration.

The airflow generating device of any one or more of the embodiments, further comprising at least one poke-yoke feature configured to prevent misconnection of blower attachment and the vacuum attachment.

The airflow generation device includes a housing extending between a front end and a rear end. The airflow generation device includes a passageway that extends between a first opening and a second opening, and the first opening is adjacent to the rear end of the housing. The airflow generation device includes a fan assembly positioned at least partly within the housing. The fan assembly includes a first axial fan, a second axial fan, and a motor configured to drive rotation of the first axial fan and the second axial fan. The first axial fan and the second axial fan are configured to rotate about a rotation axis that coincides with a central longitudinal axis of the passageway. The airflow generation device includes a knob extending from the housing. The airflow generation device includes a blower attachment and a vacuum attachment configured to interchangeably couple to the housing and/or the fan assembly at the rear end of the housing. The fan assembly is rotatable such that, in a blower configuration, the first axial fan is disposed adjacent to the first opening, and in a vacuum configuration, the second axial fan is disposed adjacent to the first opening, wherein rotation of the knob transitions the fan assembly between the first configuration and the second configuration. The airflow generating device further includes at least one poke-yoke feature configured to prevent misconnection of blower attachment and the vacuum attachment based on a configuration of the fan assembly.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An airflow generating device comprising:
a housing extending between a front end and a rear end;
a passageway that extends between a first opening and a second opening, wherein the first opening is adjacent to the rear end of the housing;
a fan assembly positioned at least partly within the housing and comprising a first fan, a second fan, and a motor configured to drive rotation of the first fan and the second fan; and
a blower attachment and a vacuum attachment configured to interchangeably couple to the housing and/or the fan assembly at the rear end of the housing;
wherein the fan assembly is rotatable such that, in a first configuration, the first fan is disposed adjacent to the first opening, and in a second configuration, the second fan is disposed adjacent to the first opening.

2. The airflow generating device of claim 1, wherein the fan assembly is configured to rotate about an axis to transition from the first configuration to the second configuration.

3. The airflow generating device of claim 1, wherein the first fan and the second fan are configured to rotate about a rotation axis that coincides with a central longitudinal axis of the passageway.

4. The airflow generating device of claim 3, further comprising a third configuration of the fan assembly in the rotation axis of the first fan and the second fan does not coincide with the central longitudinal axis of the passageway.

5. The airflow generating device of claim 1, wherein the motor is configured to rotate about a rotation axis that coincides with a central longitudinal axis of the passageway.

6. The airflow generating device of claim 1, further comprising a knob extending from the housing, wherein rotation of the knob transitions the fan assembly between the first configuration and the second configuration.

7. The airflow generating device of claim 1, wherein the motor is disposed between the first fan and the second fan.

8. The airflow generating device of claim 1, wherein the first fan is coupled to a rotation shaft of the motor, and the second fan is coupled to the rotation shaft via a secondary shaft and a gear assembly.

9. The airflow generating device of claim 1, wherein the first fan and the second fan are driven by the motor to rotate in opposite directions.

10. The airflow generating device of claim 1, wherein the second fan rotates at half the speed of the first fan.

11. The airflow generating device of claim 1, wherein the blower attachment and the vacuum attachment are each configured to correspond to one of the first configuration or the second configuration of the fan assembly.

12. The airflow generating device of claim 1, further comprising a battery housing disposed on a front side of the housing.

13. The airflow generating device of claim 1, further comprising a microswitch configured to detect the presence of the blower attachment or the vacuum attachment coupled to the housing.

14. The airflow generating device of claim 1, further comprising a first motor cooling airflow opening and a second motor cooling airflow opening;
wherein, during operation of the airflow generating device in the first configuration, a first motor cooling airflow opening provides motor cooling intake airflow and a second motor cooling airflow opening provides motor exhaust airflow; and,
during operation of the airflow generating device in the second configuration, the second motor cooling airflow opening provides motor cooling intake airflow and the first motor cooling airflow opening provides motor exhaust airflow.

15. The airflow generating device of claim 14, further comprising an airflow separation rib in a housing of the fan assembly provided between the first motor cooling airflow opening and the second motor cooling airflow opening.

16. The airflow generating device of claim 1, further comprising a mulch blade coupled to the first fan.

17. The airflow generating device of claim 1, wherein the blower attachment is configured to couple to the housing and/or the fan assembly in the first configuration, and the vacuum attachment is configured to couple to the housing and/or the fan assembly in the second configuration.

18. The airflow generating device of claim 17, further comprising at least one poke-yoke feature configured to prevent misconnection of blower attachment and the vacuum attachment.

19. The airflow generating device of claim 18, wherein the poke-yoke feature comprises a poke yoked track mounted to a fan assembly housing, wherein the poke yoked track has a first track side corresponding to the first configuration and a second track side corresponding to the second configuration, wherein the track is configured to receive a pin of an attachment arm of the blower attachment or an attachment arm of the vacuum attachment, wherein the attachment arm of the blower attachment further includes a stop, further wherein, when the pin of the blower attachment is inserted into the poke yoked track, the stop prevents the fan assembly from rotating in a direction of the second configuration to prevent misconnection of the blower attachment.

20. An airflow generating device comprising:
a housing extending between a front end and a rear end;
a passageway that extends between a first opening and a second opening, wherein the first opening is adjacent to the rear end of the housing;
a fan assembly positioned at least partly within the housing and comprising a first axial fan, a second axial fan, and a motor configured to drive rotation of the first axial fan and the second axial fan, wherein the first axial fan and the second axial fan are configured to rotate about a rotation axis that coincides with a central longitudinal axis of the passageway;
a knob extending from the housing;
a blower attachment and a vacuum attachment configured to interchangeably couple to the housing and/or the fan assembly at the rear end of the housing;
wherein the fan assembly is rotatable such that, in a blower configuration, the first axial fan is disposed adjacent to the first opening, and in a vacuum configuration, the second axial fan is disposed adjacent to the first opening, wherein rotation of the knob transitions the fan assembly between the first configuration and the second configuration; and
wherein the airflow generating device further includes at least one poke-yoke feature configured to prevent misconnection of blower attachment and the vacuum attachment based on a configuration of the fan assembly.
